(19) United States
(12) Patent Application Publication
(10) Pub. No.: US 2021/0267737 A1
(43) Pub. Date: Sep. 2, 2021

(54) DEVICE FOR STORING ORTHODONTIC PLIERS

(71) Applicant: FRANÇOIS DAMAY, BOULOGNE SUR MER (FR)

(72) Inventor: FRANÇOIS DAMAY, BOULOGNE SUR MER (FR)

(21) Appl. No.: 17/056,698

(22) PCT Filed: May 22, 2019
(86) PCT No.: PCT/IB2019/054220

§ 371 Date: Nov. 18, 2020

(30) Foreign Application Priority Data
May 24, 2018 (FR) 18/70599

(51) Int. Cl. A61C 19/02; A61C 7/04

(52) U.S. Cl. CPC A61C 19/02; A61C 2201/00; A61C 7/04

(57) ABSTRACT

A device to store at least one set of orthodontic pliers. The device includes a case consisting of a material which is impenetrable to light and at least one storage housing. The storage housing includes a flap mounted to move rotatably between a closing position and an opening position. In the closing position, the flap creates an insertion opening and in the opening position, the flap is at a distance from the storage housing and provides access thereto. A holder comprises a narrowing formed in the storage housing or in the region of the insertion opening, by the cooperation of the inner surface of the storage housing and the flap in the closing position.

### FIELD OF THE INVENTION

The present invention relates to a device for storing orthodontic pliers.

### BACKGROUND OF THE INVENTION

The fitting of an orthodontic device of the “multi-ring” or “multi-fastener” type requires gluing orthodontic dots on the surface of certain teeth. These dots are then connected by a metal arch which allows, due to the mechanical stresses that it exerts, to modify the relative placement of the teeth.

The fitting takes a long time, as each dot must be disposed on pliers also called tweezers, bonding the dot and finally gluing on the tooth while manipulating it using the pliers. With the glue being a photopolymerizable composition, the fitting of the dot on the tooth must be immediate; the practitioner must therefore work with an assistant who prepares the dots for them, disposed on pliers gradually.

Document U.S. Pat. No. 5,810,582 B1 describes a case for the storage of orthodontic pliers/tweezers which allows to store the bonded dots disposed on the pliers. The device described in this document includes a case made of a material which is impenetrable to light which includes several vertical housings, each being opened in the region of an insertion opening. The insertion opening includes an annular flat spot. The pliers have a gripping end and a mounting end, which allows the holding of the dot bonded beforehand. A silicon cap is fitted onto the gripping end of the pliers. This cap includes an annular stop which bears against the annular flat spot of the insertion opening, thus allowing the hold the pliers suspended in the housing, away from ambient light, the dot bonded beforehand not touching the bottom of the housing.

This device has several disadvantages. The insertion of the end of the pliers carrying the dot bonded beforehand is not easy, indeed attention must be paid to not knocking the dot against the edges of the insertion opening. This is unacceptable in the case of pliers adapted for the fitting of the dot on a molar and which therefore includes a curved end, deported laterally with respect to the gripping end.

The pliers must be sterilized after use. Therefore, ideally, the cap must be removed, and the pliers and the cap must be sterilized. Before use, the cap must be put back on the pliers, separately.

If a dot falls into the device, the case must be returned, and it must be shaken to recover the dot from it, or a sliding flap must be opened.

An aim of the present invention is to propose a device for storing at least one set of orthodontic pliers which overcomes at least one of the disadvantages linked to the device of the prior art.

### OBJECT AND SUMMARY OF THE INVENTION

The present invention relates to a device allowing the storage of at least one set of orthodontic pliers, said device being of the type comprising a case, made of a material which is impenetrable to light, said case including at least one storage housing capable of receiving pliers, said storage housing leading to the surface of said case in the region of an insertion opening, said storage housing comprising means for holding orthodontic pliers.

According to the invention, characteristically, said storage housing includes an inner surface and said case includes a flap, which is mounted such that it can move rotatably between a closing position, in which said flap cooperates with said inner surface of said storage housing to form said insertion opening and said storage housing, and an opening position in which said flap is at a distance from said inner surface of said storage housing and allows access thereto; said holding means include a narrowing formed in said storage housing or in the region of said insertion opening, by the cooperation of said inner surface of said storage housing and said flap, in said closing position of the latter.

When the device includes several storage housings, they are advantageously separated from one another by impenetrable side walls; thus, when the flap of one of the housings is open, light does not penetrate in the adjacent housings.

The flap allows to easily access the inside of the case and to remove a dot which would have fallen inside the latter, without having to shake the case. The other pliers can thus remain in the case without any damage.

The flap allows to easily insert the pliers on which the bonded dot is mounted in the storage housing. The user no longer has to fear knocking the dot in the region of the edge of the insertion opening. The flap allows to laterally insert the pliers in the storage housing. The narrowing allows to hold the pliers vertically suspended in the storage housing, without the dot touching the bottom of this housing. The cooperation between the narrowing and the restriction of the pliers or the stop thereof allows, on the one hand, this holding in suspension of the pliers, and on the other hand, prevents light from passing to the bottom of the storage housing, beyond the narrowing; the narrowing which is the only passage of light penetrating through the insertion opening is indeed blocked by the pliers.

The device of the invention allows to save time by allowing the storage of dots bonded beforehand; the practitioner or the assistant can prepare the prebonding of the dots at a suitable time of the day in order to optimize the work of the surgery, then to be used for fitting the device, without using an assistant or a third party. In addition, each set of pliers having its own storage housing, any contamination is avoided during fitting. The device of the invention therefore allows a hygienic storage of the dots mounted on the pliers.

According to a particular embodiment, the case has a first support surface which allows to fit it on a substantially horizontal surface such that said storage housing is vertical, said insertion opening being disposed opposite said first support surface. In this position, it is easy to remove the pliers and to insert them in the case due to the presence of the flap.

The flap can be disposed in the open position or in the closed position and remain in either of these positions, by friction, in particular; it can also be equipped with return means which allow to bring it back from the open position thereof to the closed position thereof.

Advantageously, said case can include a second support surface which allows to fit said case on a substantially horizontal surface such that said storage housing is substantially horizontal, the flap being disposed opposite said second support surface. The case can thus be disposed horizontally or vertically. The horizontal position can facilitate the insertion of the pliers, the vertical position can be more suited to the storage of the latter (they are suspended, the dot bonded away from light) and to the use thereof by the practitioner.

The device can also, according to a variant which can be combined with any one of the embodiments of the invention, include a support plate capable of holding the case in the vertical position thereof. According to a particular embodiment of the flap which can be combined with any one of the abovementioned embodiments, said flap includes an inner surface on which is arranged a first protrusion, said first protrusion forming said narrowing in said closing position of said flap. The narrowing is thus easily formed.

This first protrusion can have a substantially triangular transversal cross-section, the free top forming said narrowing.

According to another embodiment which can be combined with any one of the abovementioned embodiments, said inner wall of said storage housing includes a second protrusion which cooperates with said first protrusion to form said narrowing, said second protrusion optionally having substantially the same shape as said first protrusion.

Advantageously, said narrowing is formed in said storage housing, upstream of said insertion opening and said storage housing has between said narrowing and said insertion opening, a portion of which the cross-section is narrowed to said insertion opening. Advantageously, in all the abovementioned embodiments, said inner surface of said housing and/or said inner surface of said flap has/have a suitable shape for coming partially into contact with pliers disposed on said inner surface of said flap, on said inner surface of said storage housing or in said storage housing, said flap being in closed position and said contact is made in the region of said narrowing and upstream of said narrowing, in the direction of said insertion opening. The contact zone is thus increased between the pliers housed in the storage housing and the wall of the housing; it results from this that the concealing from light of the portion of the housing situated after the narrowing is optimal.

The storage housing can further include concealing means allowing to avoid the passage of light in the region of said insertion opening. These concealing means are useful when the insertion opening is not adjusted to the size or the shape of the pliers and/or when the narrowing is not the only place of passage of light filtering through the insertion opening.

These concealing means are not limited according to the invention. They can, for example, include a flap capable of cooperating with said inner surface of said storage housing to block at least partially said insertion opening. This flap can be disposed in the storage housing. This flap can be disposed in the storage housing, under the insertion opening, in particular when the latter also leads to the housing by place other than the narrowing. This flap is particularly useful when the storage housing is wide to allow the storage of pliers with a curved end. The presence of this flap allows to arrange an insertion opening over the whole width of the housing; the flap then blocks and conceals the portion of the insertion opening which is not already blocked by the pliers disposed in the storage housing.

The device of the invention can also further include a set of orthodontic pliers selected from among pliers including two crossed blades forming a restriction and a gripping end, the pliers having a substantially tubular body including a gripping end and hollow or relief stop, said abovementioned pliers optionally having a curved end and said pliers being optionally housed in said storage housing.

In any case, the pliers include a portion situated beyond the restriction or the stop (including the mounting end) which is thinner or of the same cross-section as the gripping end.

The case can be formed of an assembled part or module, as explained in the description below.

### BRIEF DESCRIPTION OF THE DRAWINGS

The present invention, the features thereof and the different advantages that it provides will appear better upon reading the following description of an embodiment of the present invention and of three embodiment variants of the base module being used as the embodiment of this embodiment, presented as non-limiting examples and which makes reference to the appended drawings, in which:

FIGS. 1A to 1C represent front and profile views of three types of pliers already known and commonly used in orthodontics;

FIG. 2 represents a partial perspective view of an embodiment of the invention, the case being vertical;

FIG. 3 represents a transversal cross-sectional view of a first variant of the base module equipping the embodiment of FIG. 2, in which is housed a set of orthodontic pliers;

FIG. 4 represents a partial, transversal cross-sectional view of a base module according to a second variant; and

FIG. 5 represents a perspective side view of a longitudinal cross-section of an embodiment variant of the module of the embodiment of FIG. 2.

### DETAILED DESCRIPTION OF THE EMBODIMENTS

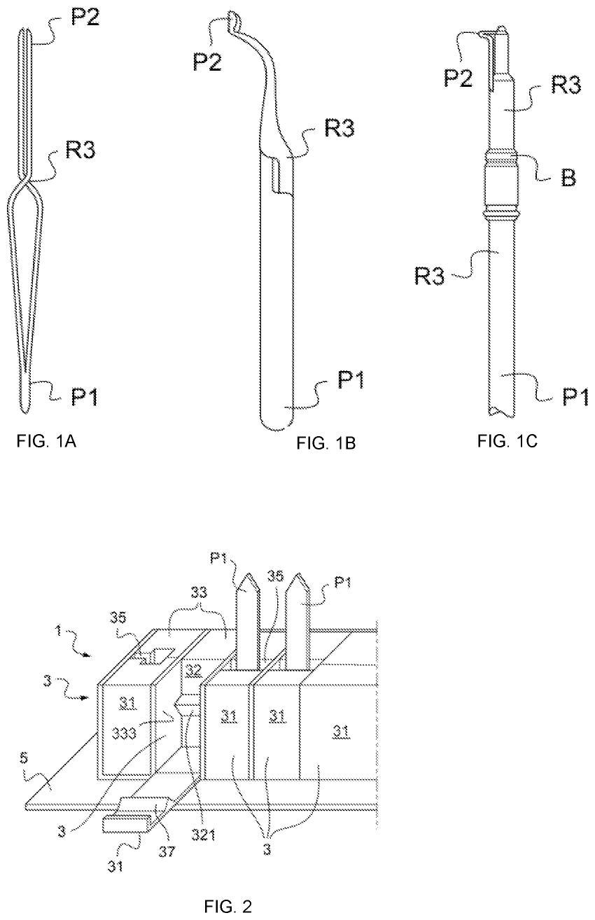

Pliers are instruments which allow to grip, hold and fit orthodontic dots. The three types of pliers used are represented in FIGS. 1A to 1C.

FIG. 1A represents so-called self-clamping pliers. These pliers include a gripping end P1 and an end P2 forming a clamp which allows the holding of an orthodontic dot (not represented). These pliers are formed of two blades which cross over and form a restriction R3, i.e. a zone where the width of the pliers is minimal. By pressing on the two blades to move them closer together in the region of the gripping end P1, the two blades are deviated from one another, in the region of the end P2, which allows to release the dot. Without pressure on the blades, the dot is held in the region of the end P2.

FIG. 1B represents a front view of plies similar to that of FIG. 1A, but which includes an end P2 which is laterally deported with respect to the gripping end P1. The pliers therefore include a curved portion in the region of the end P2 thereof. These pliers are used for the fitting of dots on molars.

FIG. 1C represents pliers which include a substantially cylindrical body, which includes a relief portion which forms a stop B; in this case, it is considered that the pliers include a restriction R3 (decrease of the diameter of the body) upstream and downstream of the stop B. The stop is mobile in translation along the body of the pliers and allows to actuate the end in the form of a clamp which holds the dot.

In reference to FIG. 2, according to a particular embodiment, the case 1 is formed by the assembly of modules 3 each including a storage housing. The case and the modules which compose it are made of material, which is impenetrable to light, for example, made of black plastic. The modules 3 each include 4 side walls, a bottom wall, a flap 31 and an upper face 33, in which is arranged the insertion opening 35. FIG. 2 partially represents the device of the invention. The case 1 also includes the modules 3 which are adapted to receive pliers for the fitting of a dot on molars (see the module most to the left in FIG. 2) and modules 3 adapted to straight pliers. The modules 3 are fixed to one another so as to form a case 1 of which the front face includes the flaps 31 and of which the rear face (which cannot be seen in FIG. 2) is flat. In FIG. 2, the case is mounted on a support plate 5, in which it is interlocked, and which allows to hold it vertically, the insertion openings 35 directed upwards. The bottom of the case 1 therefore forms the first support surface while the rear face of the case 1, which is opposite the face including the flaps 31, forms the second support surface. The case 1 can therefore be fitted flat, the flaps 31 extending horizontally in the closed position thereof and rotated upwards. The support plate 5 is optional and the device of the invention can only comprise the case.

As represented in FIG. 2, the flap 31 includes a protrusion 37 arranged on the face thereof which faces the inner face of the body 32 of the module 3, to form the storage housing, when the flap 31 is closed. It is observed that when the flap 31 is closed, the gripping end P1 of the pliers vertically exceeds the case. The body 32 of the module 3 includes, facing the protrusion 37, an identical protrusion 321 which allows to suspend, when the flap 31 is closed, the pliers P, in the region of the restriction zone R3 of the latter.

As represented in FIG. 2, each module 3 includes side walls 333 which insulate it from the two other modules which are adjacent. These walls 333 are impenetrable to light and allow to not let light penetrate in the other modules, when the flap 31 of a module is open. The side walls 333 can be molded during the process for manufacturing the module.

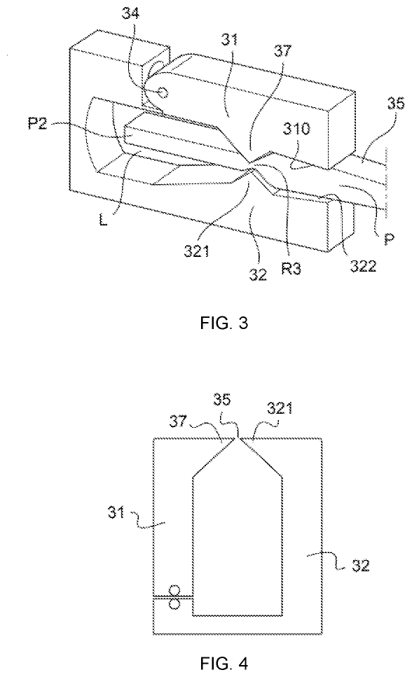

The module 3, adapted to receiving straight pliers according to the first abovementioned embodiment will now be described in reference to FIG. 3. In FIG. 3, the module 3 is represented horizontally, the flap 31 being disposed upwards. The module 3 includes a body 32 which forms the rear wall of the storage housing, the bottom wall thereof and a portion of the front wall thereof. The side walls 333 are not represented, for reasons of simplification. The flap 31 is mounted rotatably on the body 32 so as to form the front wall of the module, when it is folded towards the module 3, in a closed position. A hinge 34, which could be a friction hinge, for example, allows to manually make the flap 31 tilt, from the open position thereof, in which it is at a distance from the inner face of the module 3 and allows access to the storage housing in the region of the front face of the case, to the closed position thereof, in which it forms the front face of the storage housing; the latter is not thus more open than in the region of the opening 35 formed by the thickness of the body 32 and that of the flap 31. In FIG. 3, pliers P of the type of that represented in FIG. 1A is disposed between the inner surface of the flap 31 and the inner surface of the body of the housing 32. The body 32 includes a protrusion 321, of substantially triangular transversal cross-section, symmetrical to the protrusion 37 and which faces the latter. The protrusion 37 is situated on the inner face of the flap 31. When the flap 31 is in a closed position, the restriction R3 of the pliers P is disposed between the tops facing the two protrusions 37 and 321. The storage housing is expanded upstream of the narrowing, forming the cavity L, so as to limit the risks of contact with the dot disposed on the pliers. When the module 3 is disposed vertically, the pliers P is suspended in the storage housing, the gripping end P1 thereof exceeding the closed module 3, the end P2 thereof including the bonded dot being situated in the cavity L of the housing; this cavity being disposed towards the bottom of the housing, behind the protrusions 321 and 37. In the embodiment represented in FIG. 3, the contact surfaces 310 and 322 respectively of the body 32 and of the flap 31, come into contact with the surface of the pliers P thus ensuring the perfect concealing of the cavity L of the storage housing. Thus, between the narrowing formed by the tops of the protrusions 37 and 321 and the insertion opening 35, the storage housing has a cross-section of which the surface is not constant: the cross-section of this portion of the storage housing is expanded from the insertion opening 35 to a given position then is narrowed to form the narrowing. This particular configuration of the storage portion situated between the narrowing and the insertion opening allows to deviate the flap 31 of the inner surface of the housing, under the effect of the vertical movement of pliers housed in the housing (the housing being also disposed vertically), by a sufficient distance to allow the passage of the whole length of the pliers, without risk of contact with the end of the pliers including the dot. It also allows to avoid the passage of light towards the inside of the housing by molding the surface of the pliers, as explained above.

In reference to FIG. 3, the contact surface 310 corresponds to the portion of the inner surface of the flap 31, situated between the free end of the flap 31 and the protrusion 37; the contact surface 322 is situated on the inner surface of the body 32 of the storage housing, between the insertion opening 35 and the protrusion 321. The inner surface of the body 32 of the module 3 is symmetrical to that of the inner face of the flap 31, with respect to a plane passing through the middle of the storage housing and parallel to the flap 31, in a closed position.

In reference to FIG. 4, according to an embodiment variant of the module 3 represented in FIG. 2 and FIG. 3, the protrusions 37 and 321 form the opening 35. The latter is of adapted dimension to cooperate with the width of the pliers P, in the region of the restriction zone R3 thereof. The pliers P is thus held suspended in the storage housing, the restriction zone R3 thereof being held clamped between the flap 31 and the protrusion 321 of the body 32 of the storage housing. In this embodiment, the width of the opening 35 corresponds to the thickness of the restriction zone R3 while the length thereof (in the direction of the length of the case 1 such as represented in FIG. 2) corresponds to the width of the pliers P.

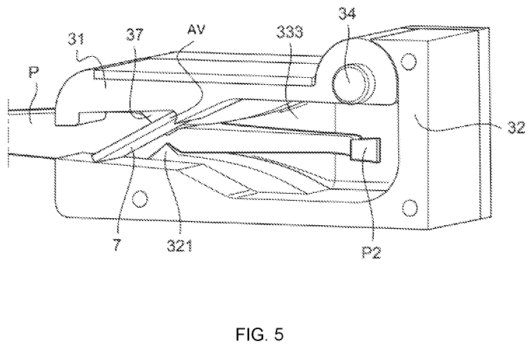

In reference to FIG. 5, an embodiment variant of the module 3 (one single side wall is represented) represented in FIG. 2 will now be described. This embodiment variant is adapted for the storage of curved end pliers for the fitting of dots on molars, like for example, represented in FIG. 1B. The elements in common with the first embodiment are referenced identically. In reference to FIG. 5, the flap 31 is in a closed position, horizontally, the case 1 being disposed horizontally, the opening 35 oriented laterally. The pliers P are born against the contact surface 310 of the flap 31 and against a face of the protrusion 37. The protrusion 37 extends over a portion of the width of the flap 31. The protrusion 321 of the body 32 extends facing the protrusion 37. According to a variant not represented, the protrusion 321 extends over the whole width of the storage housing. The flap 31 in a horizontal position and the surface of the body 32, of which the protrusion 321, can be used to support pliers P. A flap 7 is mounted at the side of the protrusion 37, on the inner face of the flap 31, according to the width of the latter. This flap 7 is mounted mobile rotatably about an axis AV, horizontal in FIG. 5 and passing through the protrusion 37. The flap 7 can freely pivot about the axis thereof, which is parallel to the width of the flap 31. In a horizontal position, the end of the flap bearing against the inner face of the body 32 of the storage housing, thus blocking the portion of the opening 35 which is not blocked by the pliers P; the inside of the storage housing is thus away from light. When the case is disposed vertically, as represented in FIG. 2, due to the free rotation thereof, the flap 7, under the effect of the weight thereof, remains in contact with the inner wall of the body 32 forming the housing, and therefore continues to protect the inside of the storage housing from light. During the opening of the flap 31, to exit the pliers P, the flap 31 being at a distance from the body 32 of the storage housing, the flap 7 is also at a distance from the inner wall of the body 32 and therefore does not impede the extraction of the pliers P at all; it therefore does not risk knocking the dot during the passage of the pliers P through the opening 35. This flap 7 avoids arranging an opening 35 with precise dimensions adapted to each set of pliers and in addition allows the storage of pliers having a curved end.

In reference to FIG. 5, it is observed that the end P2 of the pliers P is correctly situated in the region of the flap 7, below the latter and therefore perfectly protected from light, whatever the position of the case.

The use of the case 1 will now be explained in reference to FIGS. 2 to 5. The bonded dot is mounted at the end P2 of the pliers P. The user tilts the case 1 such that the flap 31 is situated on the face of the top of the case 1, the latter being horizontal, bearing on the second support surface thereof. The user opens the flap 31 of a module 3 adapted to the pliers P and positions the pliers P on the protrusion 321 and on the surface 322 of the body 32 of the module 3. The latter are exactly the same as the protrusion 37 and the surface 310 and can therefore be used to support the pliers P. In this position, the pliers are stable and the end P2 thereof which carries the dot does not touch the bottom of the storage housing. The user then closes the flap 31 on the body 32 of the module 3. The pliers P, horizontal, come into contact with the inner surface of the flap 31 in the region of the protrusions 37 and 321. Light cannot therefore penetrate in the cavity L of the storage housing due to the contact between the pliers and the walls of the flap 31 and of the body 32 of the module 3. The bonded dot is therefore away from light. The user likewise proceeds for each set of pliers. For curved end pliers, they use the modules 3 of the case which correspond to the second embodiment variant. When the flap 31 is closed, with the case being horizontal, the mobile flap 7 blocks the opening portion 35 not blocked by the pliers themselves. The dot is therefore also away from light.

When all the pliers are disposed in the case 1, away from light, the user straightens the case 1 and fits it on the base 5. The flaps 31 are vertical and the gripping ends P1 of the pliers P exit the case 1, upwards, as represented in FIG. 2. The pliers P bear against the protrusions 37 and 321 which hold them suspended in the storage housing. The contact between the pliers and the walls 310 and 322, upstream of the protrusions 37 and 321 prevents the passage of the light in the cavity L of the storage housing which houses the bonded dot. The contact of the pliers P with the protrusions 37 and 321 also reinforces this concealment. The pliers themselves, becoming thicker beyond the protrusions 37 and 321 also ensures the concealment of the storage housing by blocking the possible clearance between the protrusions 7, 321 and the restriction zone R3 of the pliers P. The mobile flap 7 takes the inclination necessary to block the portion of the opening 35 which is not blocked by the pliers P, in the case of a module adapted to curved end pliers. The mobile flap 7 can be vertical or not and bears against a stop arranged on the inner surface of the body 32, thus achieving the concealment. The dots are therefore all away from light in the case 1. The fitting of the dots can be offset over time. During the fitting of the dots, the practitioner uses the pliers one by one, holding them by the gripping end P1 thereof with a hand. The vertical removal of the pliers leads to the opening of the flap 31 under the thrust exerted by the pliers moved vertically. The portion of the storage housing situated between the narrowing and the insertion opening 35 being narrowed in the direction of the insertion opening 35, the passage of the pliers deviates the flap 31 of the inner wall of the housing and expands the insertion opening 35, thus allowing the passage of the whole length of the pliers; these are, in addition, thinner towards the end thereof, capable of carrying the dot bonded beforehand. When the flap includes a flap 7, this is deviated at the same time as the flap 31 and does not impede the passage from the curved end of the pliers. The fitting of the dot is thus easy and quick. It has been able to be observed that the pliers carrying a bonded dot can remain several tens of hours in the case 1 without a modification of the glue being observed.

The present invention is not limited to a case formed from the assembly of the module 3. The case can also be made of one single part. The housings are all separated from one another by partitions so as to avoid the passage of light during the opening of any flap 31. The modules are however easy to manufacture. They can be obtained by 3D printing, in particular.

1-10. (canceled)

11. A device to store at least one set of orthodontic pliers, the device comprising a case made of a material which is impenetrable to light, the case comprising at least one storage housing configured to receive the orthodontic pliers, the storage housing comprising an inner surface, an inserting opening on a surface of the case and a holder to hold the orthodontic pliers; wherein the case comprises a flap rotatably mounted thereon between a closing position and an opening position; wherein in the closing position, the flap cooperates with the inner surface of the storage housing to form the insertion opening and the storage housing; wherein in the opening position, the flap is at a distance from the inner surface of the storage housing and provides access thereto; and wherein the holder comprises a narrowing, formed in the storage housing or in a region of the insertion opening, by cooperation of the inner surface of the storage housing and of the flap in the closing position.

12. The device of claim 11, wherein the case comprises a first support surface configured to vertically position the storage housing and a second support surface configured to horizontally position the storage housing, the insertion opening being disposed opposite the first support surface and the flap being disposed opposite the second support surface.

13. The device of claim 11, wherein the flap comprises an inner surface on which is arranged a first protrusion, the first protrusion forming the narrowing in the closing position of the flap.

14. The device of claim 13, wherein the first protrusion has a triangular transversal cross-section, a free top of a triangle forming the narrowing.

15. The device of claim 13, wherein the inner surface of the storage housing comprises a second protrusion which cooperates with the first protrusion to form the narrowing, the second protrusion optionally being a same shape as the first protrusion.

16. The device of claim 11, wherein the narrowing is formed in said storage housing; and wherein, between the narrowing and the insertion opening, a cross-section of a portion of the storage housing narrows to the insertion opening.

17. The device of claim 13, wherein a shape of at least one of the inner surface of the housing and of the inner surface of the flap is adapted to partially come into contact with the orthodontic pliers disposed on the inner surface of the flap, on the inner surface of the storage housing or in the storage housing; and wherein the flap is in a closed position and the contact is made in a region of the narrowing and upstream of the narrowing in the direction of the insertion opening.

18. The device of claim 11, wherein the storage housing further comprises a concealer to avoid a passage of light in the region of the insertion opening (35).

19. The device of claim 18, wherein the concealer comprises at least one flap configured to cooperate with the inner surface of the storage housing to block at least partially the insertion opening.

20. The device of claim 11, wherein the orthodontic pliers are selected among pliers comprising two crossed blades forming a restriction and a gripping end and pliers having a substantially tubular body comprising a gripping end and a hollow or relief stop, the orthodontic pliers being housed in the storage housing and optionally having a curved end.
